(19) United States
(12) Patent Application Publication
(10) Pub. No.: US 2025/0089006 A1
(43) Pub. Date: Mar. 13, 2025

(54) POSITION ESTIMATION SYSTEM, CONTROLLER, POSITION ESTIMATION METHOD, AND PROGRAM

(71) Applicant: NIPPON TELEGRAPH AND TELEPHONE CORPORATION, Tokyo (JP)

(72) Inventors: Ryota SHIINA, Musashino-shi, Tokyo (JP); Tomohiro TANIGUCHI, Musashino-shi, Tokyo (JP); Shinya TAMAKI, Musashino-shi, Tokyo (JP)

(73) Assignee: NIPPON TELEGRAPH AND TELEPHONE CORPORATION, Tokyo (JP)

(21) Appl. No.: 18/721,463

(22) PCT Filed: Dec. 21, 2021
(86) PCT No.: PCT/JP2021/047200

§ 371 Date: Jun. 18, 2024

(51) Int. Cl. H04W 64/00; H04W 4/38

(52) U.S. Cl. CPC H04W 64/00; H04W 4/38

(57) ABSTRACT

An object of the present invention is to provide a position estimation system, a control device, a position estimation method, and a program which are capable of estimating a position of a sensor using existing lighting as it is. The position estimation system according to the present invention makes use of the fact that, when a pattern is sent from each light source at a separate frequency, the peak intensities thereof differ in accordance with a position of a sensor if the spectrum of the received signal light is plotted. That is to say, this position estimation system estimates the position of the sensor by comparing the peak intensity ratio of the spectrum when the light pattern from each light source is received and the theoretical peak intensity ratio which serves as a reference prepared in advance.

### TECHNICAL FIELD

The present disclosure relates to a position estimation system, a control device, a position estimation method, and a program for estimating a sensor position using illumination in a communication system for IoT and a technique for improving the reliability of a communication method.

### BACKGROUND ART

NPL 1 discloses a method for estimating the position of a sensor. The estimation method of NPL 1 includes creating a plurality of different lighting gradation patterns and dimming the lighting for each lighting gradation pattern, thereby creating areas with high illuminance and areas with low illuminance for each of the plurality of lighting gradations. Also, the estimation method of NPL 1 includes measuring changes in illuminance and color temperature due to pattern changes and identifying the position of the sensor from the difference from the reference illuminance. This estimation method can detect the relative positional relationship of a plurality of terminals.

### CITATION LIST

### Non Patent Literature

[NPL 1] Yo ICHIKAWA, Hiroto HAZAMA, Ryoga OKUNISHI, and Mitsunori MIKI, “Study of Indoor Area Estimation Method Using Illuminance and Color Temperature”, Multimedia, Distributed Coordination and Mobile Symposium 2014 Proceedings, pp1,779-1784, 2014.

### SUMMARY OF INVENTION

### Technical Problem

The estimation method of NPL 1 includes synchronizing and interlocking the light sources, creating a plurality of gradation patterns of illuminance, and estimating the sensor position from the amount of difference from the reference illuminance (full lighting). Therefore, there are restrictions on the placement of the light sources and the placement of the light sources significantly affects the estimation accuracy. That is to say, the estimation method of NPL 1 has a problem that it may be difficult to use the lighting as it is depending on the arrangement of existing lighting.

Thus, in order to solve the above problems, an object of the present invention is to provide a position estimation system, a control device, a position estimation method, and a program capable of estimating the position of a sensor using existing lighting as it is.

### Solution to Problem

In order to achieve the above object, the position estimation system according to the present invention makes use of the fact that, when a pattern is sent from each light source at a separate frequency, the peak intensities thereof differ in accordance with a position of a sensor if the spectrum of the received signal light is plotted. That is to say, this position estimation system estimates the position of the sensor by comparing the peak intensity ratio of the spectrum when the light pattern from each light source is received and the theoretical peak intensity ratio which serves as reference data prepared in advance.

Specifically, a position estimation system according to the present invention is a position estimation system which includes a control device, a plurality of light sources, and a terminal, wherein
each of the light sources is fixed at an arbitrary position in a space and outputs modulated light modulated with frequency patterns different from each other,
the terminal receives each of the modulated lights in the space,
the control device controls generation and an output of the modulated light for the light source, and
a position of the terminal is estimated by referencing a peak intensity ratio array generated by arranging ratios of peak intensities of spectra of each modulated light received by the terminal with respect to reference data which is the peak intensity ratio array for each theoretical position in the space.

Also, a control device according to the present invention is a control device which controls a position estimation system including a plurality of light sources and a terminal, wherein each of the light sources is fixed at an arbitrary position in a space and outputs modulated light modulated with frequency patterns different from each other,
the terminal receives each modulated light in the space, generation and an output of the modulated light of the light source is controlled, and
a position of the terminal is estimated by referencing a peak intensity ratio array generated by arranging ratios of peak intensities of spectra of each modulated light received by the terminal with respect to reference data which is the peak intensity ratio array for each theoretical position in the space.

Furthermore, a position estimation method according to the present invention is a position estimation method for estimating a position of a terminal, the position estimation method including
outputting modulated light modulated with mutually different frequency patterns from a plurality of light sources fixed at arbitrary positions in a space,
receiving each modulated light at the terminal in the space, detecting a peak intensity of a spectrum for each modulated light,
generating a peak intensity ratio array in which the ratios of the peak intensities for each modulated light are arranged, and
referencing the peak intensity ratio array with respect to reference data which is the peak intensity ratio array for each theoretical position in the space to estimate a position of the terminal.

This position estimation system can determine a position of a sensor regardless of lighting disposition. Therefore, the present invention can provide a position estimating system, a control device, and a position estimating method which are capable of estimating a position of a sensor using existing lighting as it is.

It is preferable that the control device of the position estimation system according to the present invention perform in advance
acquiring an illuminance profile for each light source in the space,
acquiring a spectrum of the modulated light corresponding to each of the light sources, and
calculating a peak intensity of a spectrum for each modulated light at each position in the space from the illuminance profile and the spectrum, calculating a ratio of peak intensities of a spectrum for each of the modulated lights at each position in the space, and generating the reference data.

The present invention includes a program which causes a computer to function as the control device. The control device according to the present invention can also be implemented using a computer and a program and the program can be recorded on a recording medium or provided over a network.

Note that the above inventions can be combined as far as possible.

### ADVANTAGEOUS EFFECTS OF INVENTION

The present invention can provide a position estimation system, a control apparatus, a position estimation method, and a program which can estimate the position of a sensor using the existing lighting as it is.

### BRIEF DESCRIPTION OF DRAWINGS

FIG. 1 is a diagram for explaining a position estimation system according to the present invention.

FIG. 2 is a diagram for explaining a position estimation method according to the present invention.

FIG. 3 is a diagram for explaining a position estimation method according to the present invention.

FIG. 4 is a diagram for explaining a position estimation method according to the present invention.

FIG. 5 is a diagram for explaining a position estimation method according to the present invention.

FIG. 6 is a diagram for explaining a position estimation method according to the present invention.

FIG. 7 is a diagram for explaining a position estimation method according to the present invention.

FIG. 8 is a diagram for explaining a position estimation method according to the present invention.

FIG. 9 is a diagram for explaining a position estimation method according to the present invention.

FIG. 10 is a diagram for explaining a position estimation method according to the present invention.

FIG. 11 is a diagram for explaining a position estimation method according to the present invention.

FIG. 12 is a diagram for explaining a position estimation system according to the present invention.

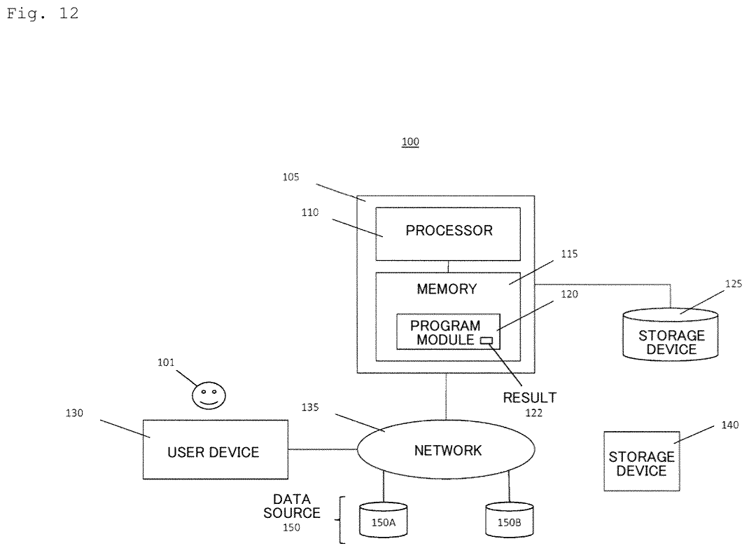

FIG. 13 is a diagram for explaining an example of storing metadata in an LLDP frame.

FIG. 14 is a diagram for explaining an example of storing metadata in an HTIP frame.

FIG. 15 is a diagram for explaining an example of storing metadata in a control system frame. A

### DESCRIPTION OF EMBODIMENTS

Embodiments of the present invention will be described with reference to the accompanying drawings. The embodiments which will be described below are examples of the present invention and the present invention is not limited to the following embodiments. Note that, in this specification and the drawings, constituent elements having the same reference numerals are the same as each other.

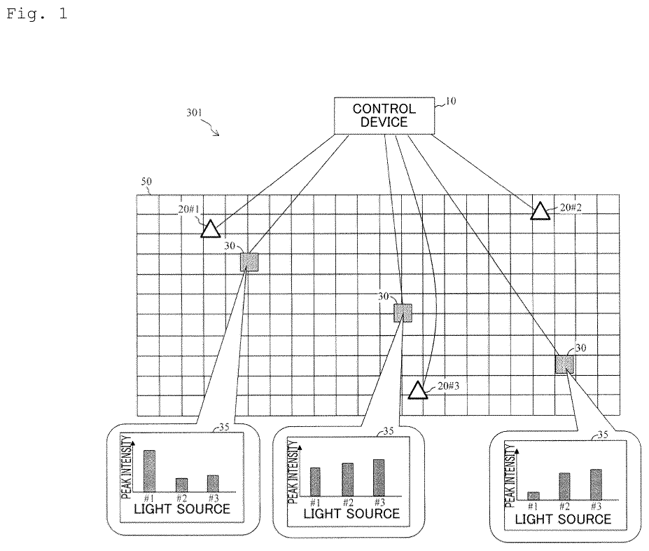

FIG. 1 is a diagram for explaining a position estimation system 301 of this embodiment. The position estimation system 301 includes a control device 10, a plurality of light sources 20, and a terminal 30. Although the number of light sources is three (light source 20 #1, light source 20 #2, and light source 20 #3) in FIG. 1, the number of light sources may be two or more. Position estimation accuracy improves as the number of light sources increases. The number of terminals 30 is arbitrary as long as the control device 10 can be identified.

Each light source 20 is fixed at an arbitrary position in a space 50 and outputs modulated light modulated with mutually different frequency patterns.

The terminal 30 receives each of the modulated light in the space 50 and transmits, to the control device 10, a peak intensity ratio array generated by arranging the ratios of the peak intensities of the spectrum of each of the modulated light.

The control device 10 controls the generation and the output of the modulated light for the light source 20 and estimates a position of the terminal 30 by referencing the peak intensity ratio array transmitted from the terminal 30 with respect to reference data which is a theoretical peak intensity ratio array for each position in the space 50.

Alternatively, the terminal 30 may receive each of the modulated light in the space 50 and send the received signal to the control device 10. In this case, the control device 10 controls the generation and the output of the modulated light for the light source, generates a peak intensity ratio array by arranging ratios of peak intensities of the spectrum of each modulated light received by the terminal 30, and estimates a position of the terminal 30 by referencing reference data which is a theoretical peak intensity ratio array for each location in the space 50.

When the position estimation system 301 compares the spectrum of the light patterns with different frequencies emitted from each light source 20 in the space 50, the position estimation system 301 utilizes the fact that the peak intensity of the spectrum differs for each light source 20 depending on the position in the space 50 (for example, refer to peak intensity comparison diagram 35 in FIG. 1). A detailed description will be provided below.

The control device 10 arbitrarily selects a plurality of light sources (for example, light source 20 #1, light source 20 #2, light source 20 #3) from the light sources 20 already arranged in the space 50. The control device 10 ascertains the position of each light source 20. The light source 20 is a room light, preferably a dimmable LED light source which outputs white or incandescent light. The control device 10 causes each of the selected light sources 20 to repeatedly transmit an optical signal which has been optically modulated to a degree imperceptible to humans (the optical signal is hereinafter referred to as an “optical pattern”). The light patterns may be sent simultaneously by each light source 20 or sent by each light source 20 at different times. The modulation frequency of optical modulation differs for each light source 20. Also, “optical modulation to the extent that humans cannot perceive” means, for example, optical modulation which is imperceptible to humans due to a low degree of optical modulation or a low or high modulation frequency.

Terminals 30 in a space receive the light patterns from each light source 20 simultaneously or separately.

The point of position estimation performed by the position estimation system 301 is to generate a “peak intensity ratio array”. The “peak intensity ratio array” may be generated using the terminal 30 or may be generated using the control device 10. Here, the latter case will be explained.

Each of the terminal 30 transmit a received signal of each light pattern to the control device 10. The control device 10 transforms (FFT) the received signal transmitted from the terminal 30 from the time domain to the frequency domain and calculates the spectrum intensity distribution. The control device 10 detects the peak intensity for each light source 20 from the calculated spectral intensity distribution. Also, the control device 10 obtains the ratios of peak intensities between the light sources 20 and generates a peak intensity ratio array by arranging them. A method for generating a peak intensity ratio array will be described later.

The control device 10 previously calculates theoretical peak intensity ratio arrays at various locations in the space 50 by simulation and has them as reference data. The control device 10 detects the corresponding position in the space 50 by performing correlation calculation between the generated peak intensity ratio array and the reference data. Note that position estimation accuracy can be improved by performing the above operations with different combinations of light sources 20 and calculating the average of the positions obtained by each operation.

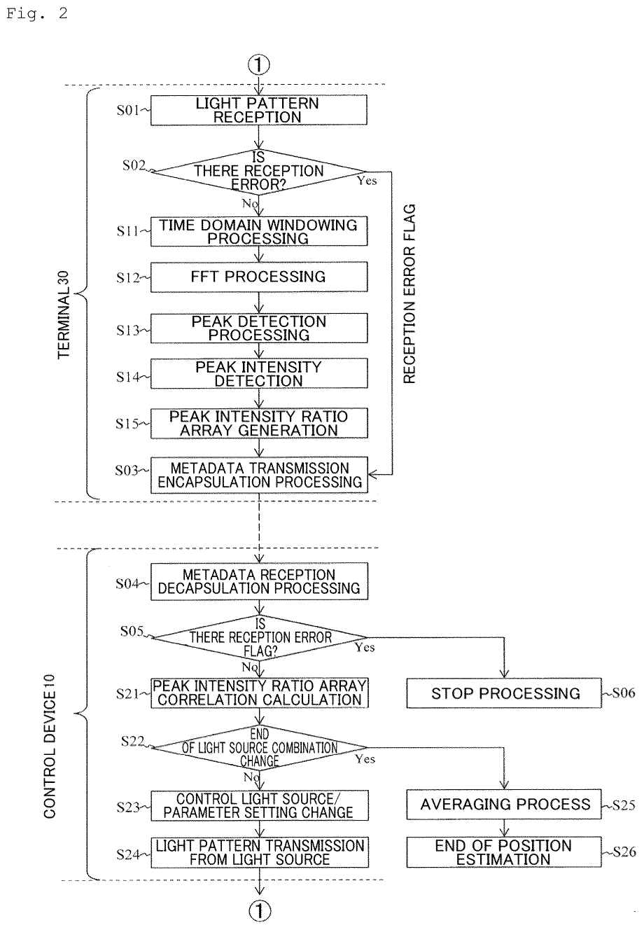

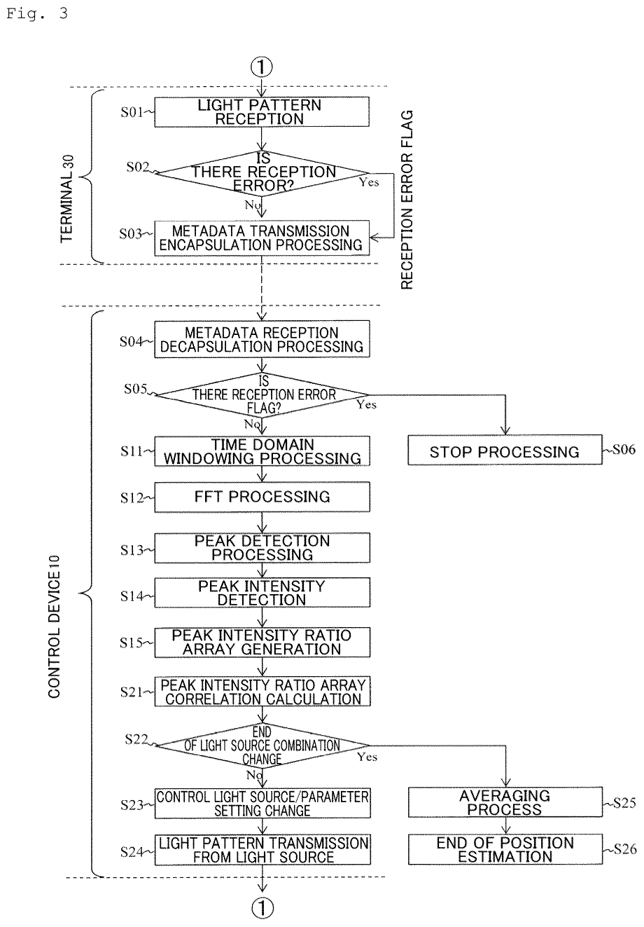

FIGS. 2 and 3 are diagrams for explaining the position estimation method performed by the position estimation system 301. FIG. 2 shows a case in which the “peak intensity ratio array” is generated using the terminal 30 and FIG. 3 shows a case in which the control device 10 generates the “peak intensity ratio array”.

This estimation method is characterized by:
outputting modulated light modulated with frequency patterns different from each other from each of the plurality of light sources 30 fixed at arbitrary positions in the space 50 (Step S24);
receiving each of the modulated light at the terminal 30 in the space 50 (Step S01);
detecting the peak intensity of the spectrum for each modulated light (Steps S03 to S14); generating a peak intensity ratio array in which the ratios of the peak intensities for each light source 20 are arranged (Step S15); and
estimating the position of terminal 30 by referencing the peak intensity ratio array with respect to reference data which is a theoretical peak intensity ratio array for each position in the space 50 (Steps S21, S22, S25, and S26).

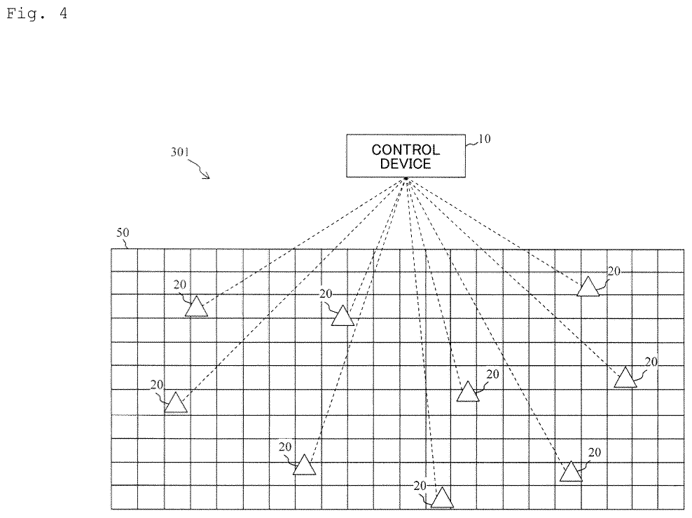

FIG. 4 is a diagram for explaining the light source 20 disposed in the space 50. A plurality of light sources 20 are arranged in the space 50. The control device 10 can control the parameters of the light pattern output by each light source 20. The parameters are, for example, the modulation frequency, the degree of modulation, and the timing of outputting the light pattern. Note that the space 50 is considered in a state in which the space 50 is divided into mesh grid cells.

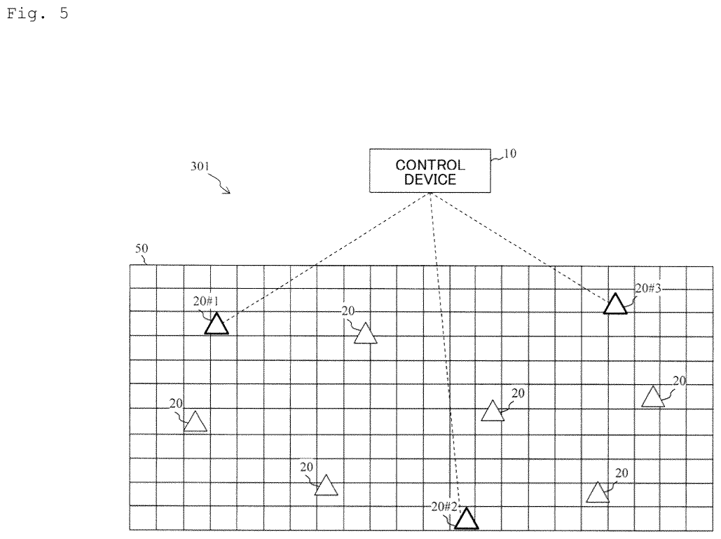

Step S23 will be explained with reference to FIG. 5. The control device 10 extracts n pairs of light sources (n is an integer of 2 or more) to be used as light sources for estimating the position of the terminal from among the plurality of light sources 20. In the case of FIG. 5, three light sources (20 #1, 20 #2, 20 #3) are selected as pairs of light sources.

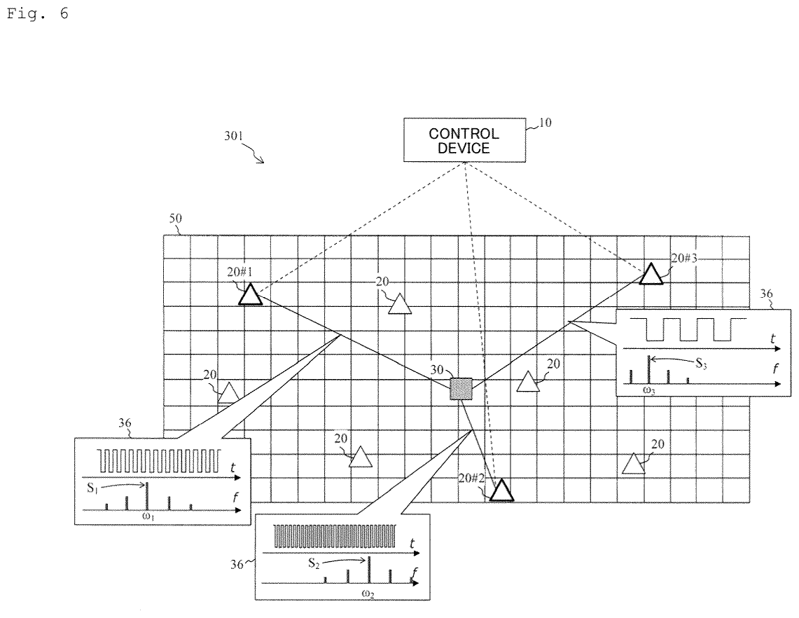

Step S23 will be further described with reference to FIG. 6. The control device 10 sets parameters for each pair of light sources (20 #1, 20 #2, 20 #3). Step S24 will be explained with reference to FIG. 6. The control device 10 causes each pair of light sources to send out a light pattern (signal waveform shown in the upper row of the display 36) modulated at an individual frequency.

Steps S01, S02, and S11 to S14 will be explained with reference to FIG. 6. The terminal 30 receives the light pattern. Here, if there is no reception error, the light pattern is subjected to FFT processing and spectrum conversion is performed (the signal waveform shown at the bottom of the display 36). Also, the peak of each spectral waveform is detected and the intensity of the peak is detected.

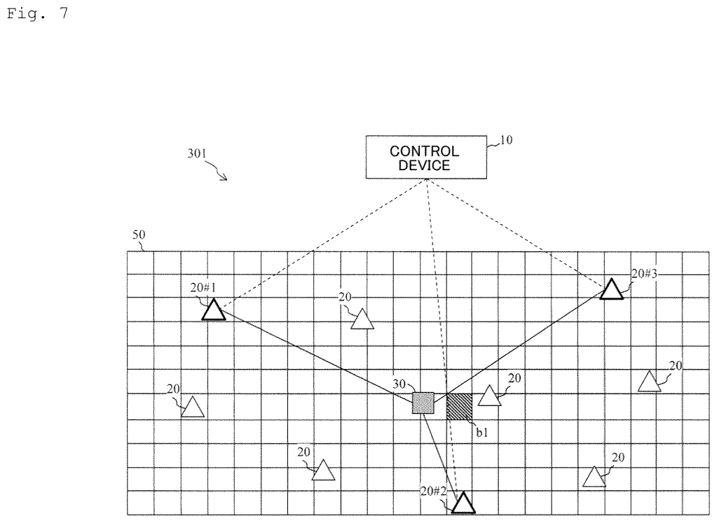

Step S15 will be described with reference to FIG. 7. In Step S15, for light source 20 #j (j=1,2, . . . , n), for (j<k)Γ_{j,k}=Sⱼ(ωⱼ)/Sₖ(ωₖ) is calculated to generate the following “peak intensity ratio array”.
[Γ_{1,2} Γ_{1,3} Γ_{2,3}]

Note that the above array is an example of k=3.

Here, k is the maximum j among light sources 20 #j (j=1,2, . . . , n) selected by the control device 10 in Step S23. Sⱼ is the peak intensity of the light source 20 #j and ωⱼ is the frequency (modulation frequency) of the peak intensity of the light source 20 #j.

The terminal 30 transmits the generated “peak intensity ratio array” to the control device 10 (Steps S03 and S04). Data transmission from the terminal 30 to the control device 10 will be explained with reference to in the Appendix which will be described later.

Note that, when a reception error occurs in Step S02, a reception error flag is transmitted from the terminal 30 to the control device 10.

If the data transmitted from the terminal 30 has an error flag (“Yes” in Step S05), the control device 10 stops the process (Step S06). On the other hand, if there is no error flag in the data transmitted from the terminal 30 (“No” in Step S05), the control device 10 performs the process of Step S21.

Step S21 will be explained with reference to FIG. 7. The correlation between the “peak intensity ratio array” generated in Step S15 and the reference data which is a theoretical “peak intensity ratio array” calculated for each mesh of the space 50 is calculated and a mesh with the highest correlation coefficient (mesh b1 in the case of FIG. 7) is extracted. This mesh b1 is the position of the terminal 30 estimated using the light sources (20 #1, 20 #2, 20 #3). Note that a method for obtaining reference data will be described later.

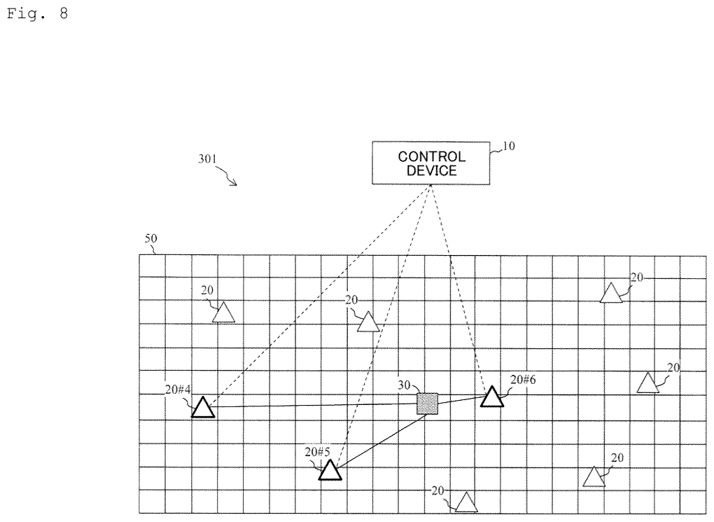

In Step S22, the control device 10 determines whether to repeatedly perform the operations from Step S23 to Step S21 via Step S01 described above. When the work is to be repeatedly performed (“No” in Step S22), Step S23 is performed again after changing the combination of the pair of light sources described above. That is to say, as shown in FIG. 8, the control device 10 again extracts n pairs of light sources to be light sources used for estimating the position of the terminal from among the plurality of light sources 20. In the case of FIG. 8, three light sources (20 #4, 20 #5, 20 #6) are selected as the pairs of light sources.

The operation from step S23 through step S01 to step S21 is repeatedly performed again using the pairs of light sources whose combination is changed, and the following “peak intensity ratio array” is generated.
[Γ_{4,5} Γ_{4,6} Γ_{5,6}]

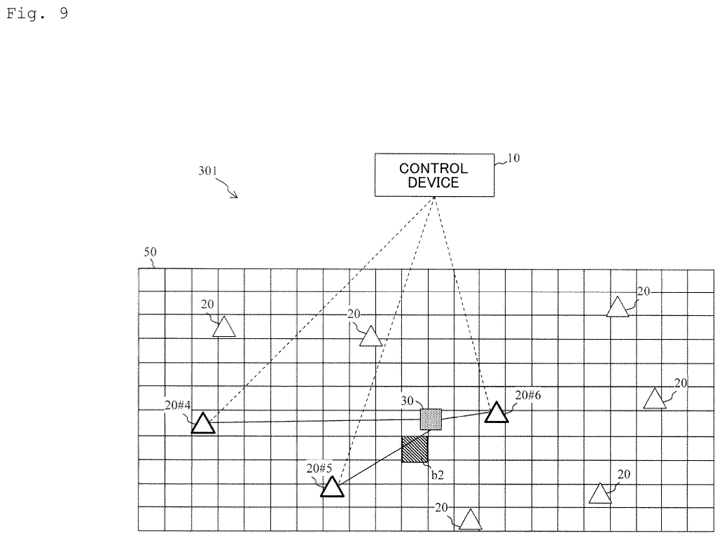

Also, as shown in FIG. 9, the correlation between the “peak intensity ratio array” generated in Step S15 and the reference data is calculated and a mesh with the highest correlation coefficient (mesh b2 in the case of FIG. 9) is extracted. This mesh b2 is the position of the terminal 30 estimated using the light sources (20 #4, 20 #5, 20 #6).

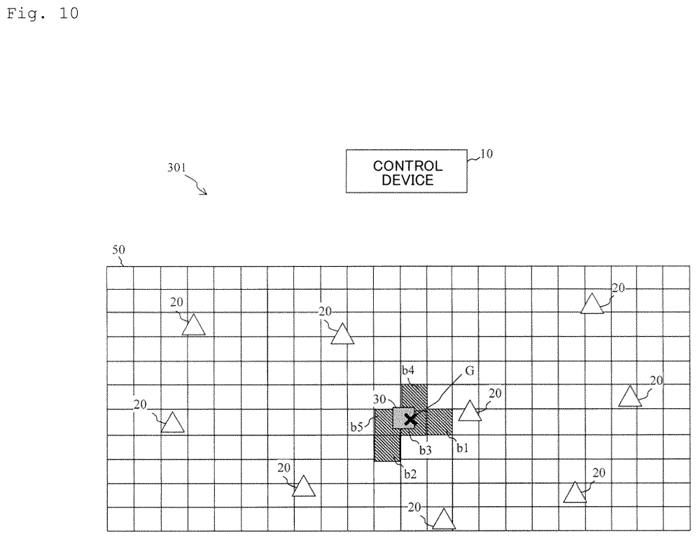

If the above operation is repeatedly performed, meshes are extracted for each combination of pairs of light sources as shown in FIG. 10 (in the case of FIG. 10, five meshes b1 to b5). The same mesh may be extracted by combining pairs of light sources and different meshes may be extracted. After repeatedly performing the above operations a specified number of times (“Yes” in Step S22), the control device 10 performs Steps S25 and S26.

Step S25 will be explained with reference to FIG. 10. In Step S25, the control device 10 estimates the position of the terminal 30 from multiple mesh positions by averaging processing or the like. For example, the control device 10 finally estimates the position of the terminal 30 by obtaining the center of gravity from the extracted M mesh positions (for example, the center position of the mesh, where M is the number of repetitions of the above work).

For example, assuming that the space 50 is the xy plane, if the center position coordinates of each mesh is assumed to be mesh b1(x₁, y₁), mesh b2(x₂, y₂), . . . mesh bM(x_{M}, y_{M}), the final estimated position G of the terminal 30 is (Σxᵢ/M, Σyᵢ/M).

Here, i is the mesh number.

Assuming that the space 50 is three-dimensional, a z coordinate will be added to the above coordinate calculation.

The control device 10 displays the estimated position of the terminal 30 on a display device or the like and ends the position estimation work (Step S26).

### Generation of Reference Data

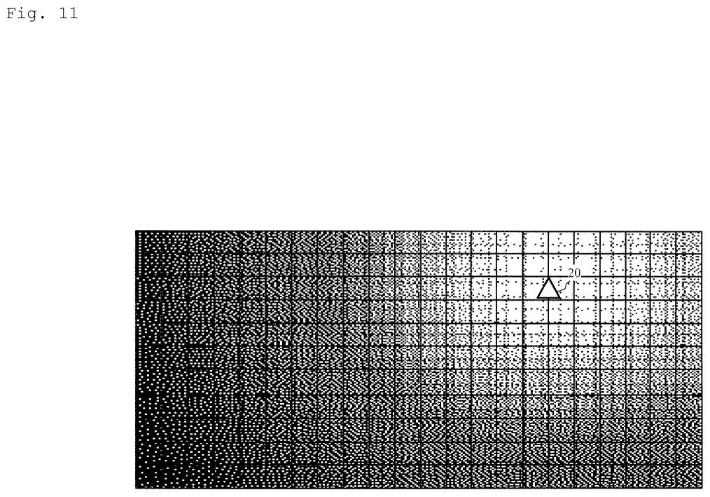

A method for generating reference data will be described with reference to FIG. 11.

The space 50 is considered in a state in which the space is divided into the same mesh grid as the mesh grid described above. The control device 10 acquires an illuminance profile in the space 50 for each light source 20 as shown in FIG. 11. Note that, in order to further improve the estimation accuracy, sample points finer than the mesh which divides the space 50 may be used and the average value thereof may be used for determining the illuminance of the mesh. Note that, although only one light source 20 is disposed in FIG. 11 for the sake of explanation, a plurality of light sources 20 are actually disposed and an illuminance profile is obtained for each light source.

The control device 10 calculates the spectrum of the light pattern output from each light source 20. The peak intensity of each mesh spectrum can be calculated from the calculated spectrum and the acquired illuminance profile. Also, the control device 10 calculates the ratio of the peak intensities of the two light patterns for each mesh to obtain a theoretical peak intensity ratio array. If there are three or more light patterns, a theoretical peak intensity ratio array is obtained for each combination of two of the light patterns. The control device 10 references these and holds them as data in a database.

### Second Embodiment

A control device 10 can also be implemented using a computer and a program and the program can be recorded on a recording medium or provided through a network. FIG. 5 shows a block diagram of a system 100. The system 100 includes a computer 105 connected to a network 135.

The network 135 is a data communication network. The network 135 may be a private network or a public network and include any or all of (a), for example, a personal area network covering a room, (b) for example, a local area network covering a building, (c) for example, a campus area network covering a campus, (d) for example, a metropolitan area network covering a city, (e) for example, wide area networks covering areas which connect across urban, rural or national boundaries, and (f) the Internet. Communication is performed using electronic and optical signals through the network 135.

The computer 105 includes a processor 110 and a memory 115 connected to the processor 110. Although the computer 105 is represented as a stand-alone device in this specification, the computer 105 is not so limited, but rather may be connected to other devices not shown in the distributed processing system.

The processor 110 is an electronic device including a logic circuit which responds to and executes instructions.

The memory 115 is a tangible computer-readable storage medium on which a computer program is encoded. In this regard, the memory 115 stores data and instructions, that is, program codes which can be read and executed using the processor 110 to control the operation of the processor 110. The memory 115 may be implemented in a random access memory (RAM), a hard drive, a read only memory (ROM), or a combination thereof. One of the constituent elements of the memory 115 is a program module 120.

The program module 120 includes an instruction for controlling the processor 110 to perform the process described in this specification. Although operations are described in this specification as being performed by a computer 105 or a method or process or subprocess thereof, those operations are actually performed using the processor 110.

The term “module” is used in this specification to refer to a functional operation which may be embodied either as a stand-alone component or an integrated configuration including a plurality of subordinate components. Therefore, the program module 120 can be implemented as a single module or as a plurality of modules which operate in cooperation with one another. Furthermore, the program module 120 is installed in the memory 115 in this specification. Therefore, although described as being implemented using software, it can be implemented using hardware (for example, electronic circuitry), firmware, software or any combination thereof.

The program module 120 is illustrated as already being loaded in the memory 115 but may be configured to be located on the storage device 140 for later loading into the memory 115. The storage device 140 is a tangible, computer-readable storage medium which stores the program module 120. Examples of the storage device 140 include compact discs, magnetic tapes, read-only memories, optical storage media, hard drives or memory units including a plurality of parallel hard drives, and universal serial bus (USB) flash drives. Alternatively, the storage device 140 may be a random access memory or other types of electronic storage device located in a remote storage system (not shown) and connected to the computer 105 over the network 135.

The system 100 further includes a data source 150A and a data source 150B collectively referred to in this specification as data sources 150 and communicatively connected to the network 135. In practice, the data source 150 may include any number of data sources, that is, one or more data sources. The data source 150 may include non-systemized data and may include social media.

The system 100 further includes a user device 130 which is operated by the user 101 and connected to the computer 105 over the network 135. The user device 130 includes an input device such as a keyboard or a voice recognition subsystem for allowing the user 101 to communicate information and command selection to the processor 110. The user device 130 further includes an output device such as a display device or a printer or a speech synthesizer. A cursor control part such as a mouse, a trackball, and a touch-sensitive screen allows the user 101 to manipulate a cursor on the display device to transfer further information and command selection to the processor 110.

The processor 110 outputs the results 122 of the execution of the program module 120 to the user device 130. Alternatively, the processor 110 can provide the output to, for example, a storage device 125 such as a database and a memory or to a remote device (not shown) over the network 135.

For example, a program which performs the flowchart in FIG. 2 (Steps S04 to S06, S21 to S26) or the flowchart in FIG. 3 (Steps S04 to S06, S11 to S15, S21 to S26) may be used as the program module 120. The system 100 can operate as the control device 10.

Although the terms “include” or “including” specify that the feature, entity, step, or constituent elements stated therein is present, it is not to be interpreted as excluding the presence of one or more other features, entities, steps or constituent elements, or groups thereof. The terms “a” and “an” are indefinite articles and thus do not exclude embodiments having a plurality thereof.

### Other Embodiments

Note that the present invention is not limited to the above-described embodiments, and various modifications can be made without departing from the gist of the present invention. In short, the present invention is not limited to the high-level embodiments as they are and can be embodied by modifying the constituent elements without departing from the scope of the present invention at the implementation stage.

Moreover, various inventions can be formed by appropriately combining a plurality of constituent elements disclosed in the above embodiments. For example, some constituent elements may be omitted from all constituent elements shown in the embodiments. Furthermore, constituent elements across different embodiments may be combined as appropriate.

### Appendix

From Steps S03 to S04 in FIGS. 2 and 3, data is transmitted from the terminal 30 to the control device. The transmission method will be described.

The terminal 30 transfers the data to be transferred to the control device 10 as metadata Dm.

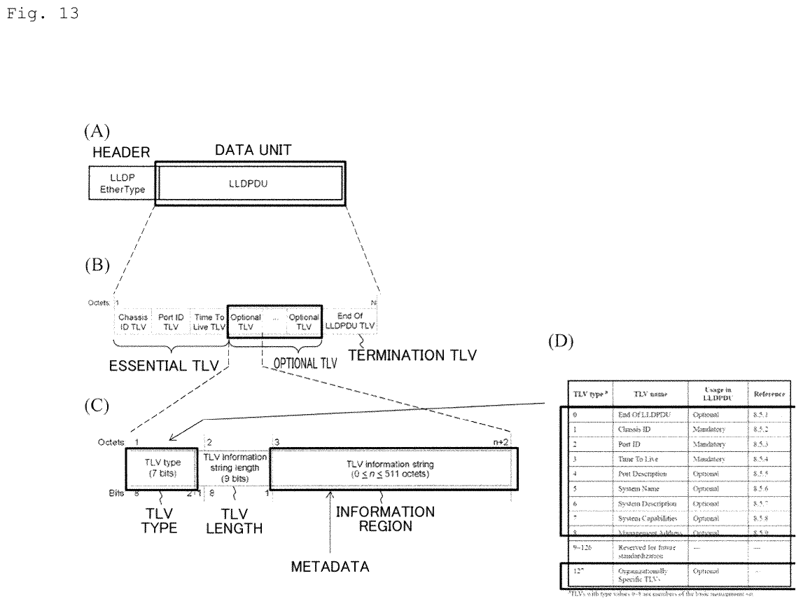

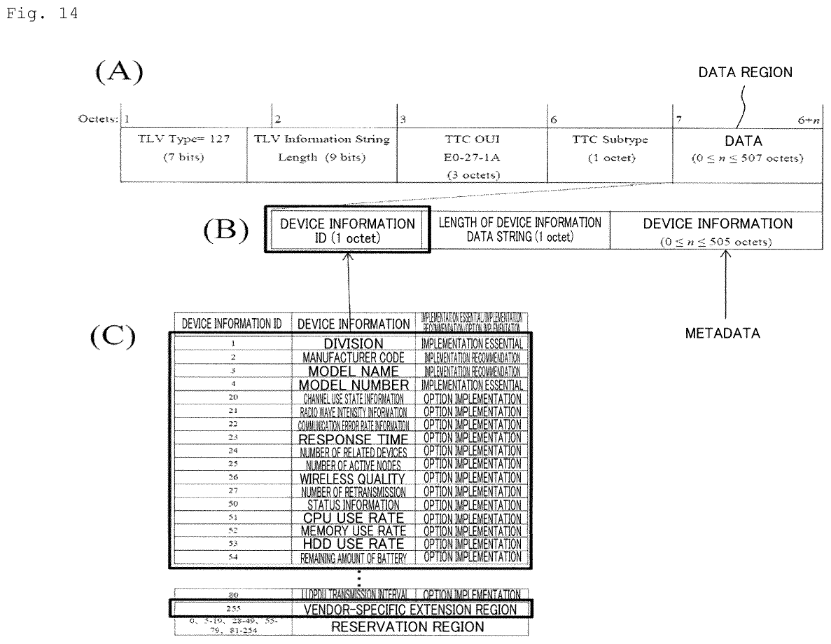

A method for storing metadata Dm and the like in the unique extension region of a control system frame will be explained. (Method 1) When the communication protocol of the network 50 adopts LLDP or HTIP, the method disclosed in International Publication WO2021/166260 or the method described in FIGS. 13 and 14 can be adopted.

FIG. 13 is a diagram for explaining an example of storing device information and metadata in a frame when LLDP (reference document 1) is adopted as a communication protocol. FIG. 13(A) is a diagram for explaining a frame configuration of LLDP. An LLDP frame is composed of a header and a data unit. FIG. 13(B) is a diagram for explaining a format of the data unit. The data unit is composed of an essential TLV, an optional TLV, and a termination TLV. FIG. 13(C) is a diagram for explaining a format of one optional TLV. The optional TLV is composed of a TLV type, a TLV length, and an information region. FIG. 13(D) is a list of optional TLV types. If “1” to “8” are input in the TLV type, various types of information such as device name, manufacturer name, MAC address, or IP address can be stored as device information in the information region of the optional TLV. Furthermore, if “127” is input in the TLV type, the information region of the optional TLV becomes an extension region and metadata can be stored. Thus, in addition to sensing data and device information, it is possible to collectively collect metadata regarding the normality of the device.
[Reference Document 1] IEEE Std 802.1AB-2016, “IEEE Standard for Local and metropolitan area networks-Station and Media Access Control Connectivity Discovery”

FIG. 14 is a diagram for explaining an example of storing device information and metadata in a frame when HTIP (Reference Document 2) is adopted as a communication protocol. FIG. 14(A) is a diagram for explaining a frame configuration of HTIP. An HTIP frame is composed of a region describing a TLV type and a length, and a data region. FIG. 14(B) is a diagram for explaining a format of the data region. The data region is composed of a device information ID, a device information data length, and device information. FIG. 14(C) is a list of device information IDs. If “1” to “4”, “20” to “27”, and “50” to “54” are input for the device information ID, various types of information such as a device name, a manufacturer name, an MAC address, or an IP address can be stored as device information in the device information region of the data region. Also, if “255” is input for the device information ID, the device information region of the data region becomes a vendor-unique extension region and metadata can be stored. Thus, in addition to sensing data and device information, it is possible to collectively collect metadata regarding the normality of the device. Although examples of storing metadata in the extension region/option region of LLDP and HTIP have been provided above as examples, the present invention is not limited thereto. In addition, other communication standards such as Wi-Fi, LPWA, PON, and the like may be used as long as the communication functions/protocols are provided by the sensor terminal 11.
[Reference Document 2] TTC Standard JJ-300.00, “Home NW Connection Configuration Specific Protocol Version 3.0”, May 25, 2017

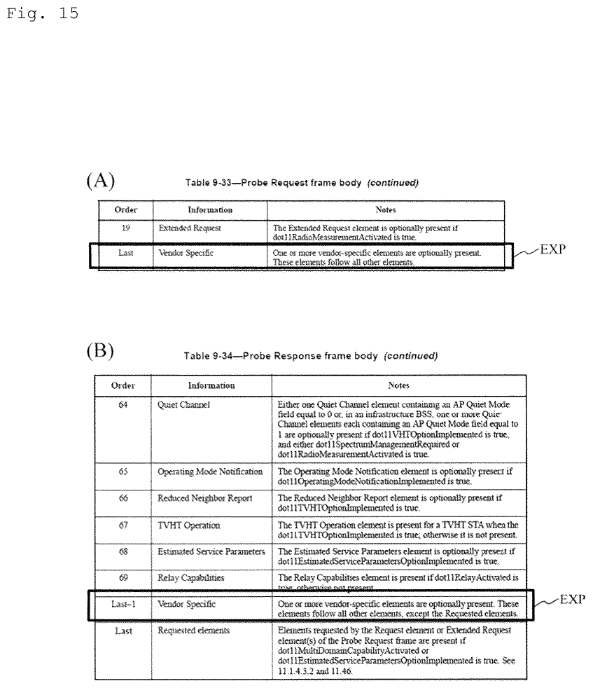

(Method 2) When the network 50 is an IEEE802.11 wireless LAN, metadata is stored in the region in the control system frame shown in FIG. 8. FIG. 15(A) is an example in which the control system frame is a probe request frame. Metadata is stored in a “Vendor Specific” region EXP. FIG. 15(B) is an example in which the control system frame is a probe response frame. Metadata is stored in the “Vendor Specific” region EXP. Note that the source of FIG. 15 is as follows.
IEEE Std 802.11-2016, p. 708-712,
IEEE Standard for Information Technology.
Local and Metropolitan Area Networks.
Specific Requirements,
Part 11: Wireless LAN MAC and PHY Specifications,

### Reference Signs List

10 Control device
20, 20 #1, 20 #2, . . . Light source
30 Terminal
100 System
101 User
105 Computer
110 Processor
115 Memory
120 Program module
122 Result
125 Storage device
130 User device
135 Network
140 Storage device
150 Data source
301 Position estimation system

1. A position estimation system which includes a control device, a plurality of light sources, and a terminal, wherein
each of the light sources is fixed at an arbitrary position in a space and outputs modulated light modulated with frequency patterns different from each other, the terminal receives each of the modulated light in the space,
the control device controls generation and an output of the modulated light for the light source, and
a position of the terminal is estimated by referencing a peak intensity ratio array generated by arranging ratios of peak intensities of spectra of each modulated light received by the terminal with respect to reference data which is the peak intensity ratio array for each theoretical position in the space.

2. The position estimation system according to claim 1, wherein the control device performs in advance
acquiring an illuminance profile for each light source in the space,
acquiring a spectrum of the modulated light corresponding to each of the light sources, and
calculating a peak intensity of a spectrum for each modulated light at each position in the space from the illuminance profile and the spectrum, calculating a ratio of peak intensities of a spectrum for each of the modulated lights at each position in the space, and generating the reference data.

3. A control device which controls a position estimation system including a plurality of light sources and a terminal, wherein
each of the light sources is fixed at an arbitrary position in a space and outputs modulated light modulated with frequency patterns different from each other, the terminal receives each modulated light in the space,
generation and an output of the modulated light of the light source is controlled, and a position of the terminal is estimated by referencing a peak intensity ratio array generated by arranging ratios of peak intensities of spectra of each modulated light received by the terminal with respect to reference data which is the peak intensity ratio array for each theoretical position in the space.

4. The control device according to claim 3, which performs in advance acquiring an illuminance profile for each light source in the space,
acquiring a spectrum of the modulated light corresponding to each of the light sources, and
calculating a peak intensity of a spectrum for each modulated light at each position in the space from the illuminance profile and the spectrum, calculating a ratio of peak intensities of a spectrum for each of the modulated lights at each position in the space,

5. A position estimation method for estimating a position of a terminal, the position estimation method comprising:
outputting modulated light modulated with mutually different frequency patterns from a plurality of light sources fixed at arbitrary positions in a space,
receiving each modulated light at the terminal in the space,
detecting a peak intensity of a spectrum for each modulated light,
generating a peak intensity ratio array in which the ratios of the peak intensities for each modulated light are arranged, and
referencing the peak intensity ratio array with respect to reference data which is the peak intensity ratio array for each theoretical position in the space to estimate a position of the terminal.

6. The position estimation method according to claim 5, comprising: performing in advance acquiring an illuminance profile for each light source in the space,
acquiring a spectrum of the modulated light corresponding to each of the light sources, and
calculating a peak intensity of a spectrum for each modulated light at each position in the space from the illuminance profile and a peak of the spectrum, calculating a ratio of peak intensities of a spectrum for each of the modulated lights at each position in the space, and generating the reference data.

7. A non-transitory computer-readable medium having computer-executable instructions that, upon execution of the instructions by a processor of a computer, cause the computer to function as the control device according to claim 3.
